(19) United States
(12) Patent Application Publication
(10) Pub. No.: US 2022/0366576 A1
(43) Pub. Date: Nov. 17, 2022

(54) METHOD FOR TARGET TRACKING, ELECTRONIC DEVICE, AND STORAGE MEDIUM

(71) Applicant: Shanghai SenseTime Lingang Intelligent Technology Co., Ltd., Shanghai (CN)

(72) Inventors: Fei WANG, Shanghai (CN); Chen QIAN, Shanghai (CN)

(21) Appl. No.: 17/857,239

(22) Filed: Jul. 5, 2022

Related U.S. Application Data
(63) Continuation of application No. PCT/CN2020/135971, filed on Dec. 11, 2020.

(30) Foreign Application Priority Data
Jan. 6, 2020 (CN) 202010011243.0

(51) Int. Cl. G06T 7/246

(52) U.S. Cl. CPC G06T 7/248; G06T 2207/10016; G06T 2207/20076; G06T 2207/20081

(57) ABSTRACT

A method for target tracking, an electronic device, and a computer readable storage medium are provided. The method includes that: video images are obtained; for an image to be tracked after a reference frame image in the video images, an image similarity feature map between a search region in the image to be tracked and a target image region in the reference frame image is generated, the target image region includes an object to be tracked; positioning location information of a region to be positioned in the search region is determined based on the image similarity feature map; and in response to determining the positioning location information of the region to be positioned, a detection box of the object to be tracked in the image to be tracked including the search region is determined based on the determined positioning location information of the region to be positioned.

### CROSS-REFERENCE TO RELATED APPLICATION

The present disclosure is a continuation of International Patent Application No. PCT/CN2020/135971, filed on Dec. 11, 2020, which is based upon and claims priority to Chinese patent application No. 202010011243.0, filed on Jan. 6, 2020. The contents of International Patent Application No. PCT/CN2020/135971 and Chinese patent application No. 202010011243.0 are hereby incorporated by reference in their entireties.

### BACKGROUND

Visual target tracking is an important research direction in the computer vision, and can be widely used in various scenes, such as automatic machine tracking, video surveillance, human-computer interaction, and unmanned driving. A task of visual target tracking is to predict, given the size and location of a target object in an initial frame of an entire video sequence, the size and location of the target object in subsequent frames, so as to obtain a moving track of the target object in the entire video sequence.

In an actual tracking prediction project, the tracking process is prone to drift and loss due to uncertain interference factors such as viewing angle, illumination, size, and occlusion. Moreover, the tracking technologies often require high simplicity and real-time performance to meet the requirements of actual deployment and application of mobile terminals.

### SUMMARY

The embodiments of the present disclosure relates to the fields of computer technologies and image processing technologies, and provide a method for target tracking, an electronic device, and a non-transitory computer readable storage medium.

According to a first aspect, an embodiment of the present disclosure provides a method for target tracking, which includes following operations.

Video images are obtained.

For an image to be tracked after a reference frame image in the video images, an image similarity feature map between a search region in the image to be tracked and a target image region in the reference frame image is generated. The target image region includes an object to be tracked.

Positioning location information of a region to be positioned in the search region is determined based on the image similarity feature map.

In response to determining the positioning location information of the region to be positioned in the search region, a detection box of the object to be tracked in the image to be tracked including the search region is determined based on the determined positioning location information of the region to be positioned.

According to a second aspect, an embodiment of the present disclosure provides an electronic device, including a processor; and a memory, coupled with the processor through a bus and configured to store computer instructions that, when executed by the processor, cause the processor to: obtain video images; for an image to be tracked after a reference frame image in the video images, generate an image similarity feature map between a search region in the image to be tracked and a target image region in the reference frame image, wherein the target image region comprises an object to be tracked; determine, based on the image similarity feature map, positioning location information of a region to be positioned in the search region; and in response to determining the positioning location information of the region to be positioned in the search region, determine, based on the determined positioning location information of the region to be positioned, a detection box of the object to be tracked in the image to be tracked comprising the search region.

According to a third aspect, an embodiment of the present disclosure further provides a non-transitory computer-readable storage medium having stored thereon a computer program that, when executed by a processor, cause the processor to perform the following operations.

Video images are obtained.

For an image to be tracked after a reference frame image in the video images, an image similarity feature map between a search region in the image to be tracked and a target image region in the reference frame image is generated. The target image region includes an object to be tracked.

Positioning location information of a region to be positioned in the search region is determined based on the image similarity feature map.

In response to determining the positioning location information of the region to be positioned in the search region, a detection box of the object to be tracked in the image to be tracked including the search region is determined based on the determined positioning location information of the region to be positioned.

### BRIEF DESCRIPTION OF THE DRAWINGS

In order to more clearly illustrate the technical solutions of the embodiments of the present disclosure, the accompanying drawings required to be used in the embodiments are briefly described below. It is to be understood that the following drawings show only some of the embodiments of the present disclosure, and therefore should not be construed as limiting the scope. Other relevant drawings will be obtained based on these drawings by those skilled in the art without creative efforts.

FIG. 1 is a flowchart of a method for target tracking according to an embodiment of the present disclosure.

FIG. 2 is a schematic diagram of determining a center point of a region to be positioned according to an embodiment of the present disclosure.

FIG. 3 is a flowchart of extracting a target image region in another method for tracking target according to an embodiment of the present disclosure.

FIG. 4 is a flowchart of extracting a search region in still another method for target tracking according to an embodiment of the present disclosure.

FIG. 5 is a flowchart of generating an image similarity feature map in yet another method for target tracking according to an embodiment of the present disclosure.

FIG. 6 is a schematic diagram of generating an image similarity feature map in still yet another method for target tracking according to an embodiment of the present disclosure.

FIG. 7 is a flowchart of training a tracking and positioning neural network in still yet another method for target tracking according to an embodiment of the present disclosure.

FIG. 8A is a schematic flowchart of a method for target tracking according to an embodiment of the present disclosure.

FIG. 8B is a schematic flowchart of positioning a target according to an embodiment of the present disclosure.

FIG. 9 is a schematic structural diagram of an apparatus for target tracking according to an embodiment of the present disclosure.

FIG. 10 is a schematic structural diagram of an electronic device according to an embodiment of the present disclosure.

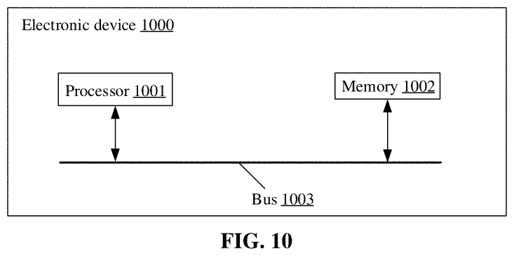

### DETAILED DESCRIPTION

In order to make the objects, technical solutions and advantages of the embodiments of the present disclosure clearer, the technical solutions in the embodiments of the present disclosure will be clearly and completely described below in conjunction with the accompanying drawings in the embodiments of the present disclosure. It should be understood that the accompanying drawings in the embodiments of the present disclosure serve only the purpose of explanation and description, and are not intended to limit the protection scope of the embodiments of the present disclosure. In addition, it should be understood that the schematic drawings are not drawn to real scale. Flowcharts used in embodiments of the present disclosure illustrate operations implemented according to some of the embodiments of the present disclosure. It should be understood that the operations of the flowcharts may be implemented out of order, and that the operations without logical context relationships may be performed in reverse order or simultaneously. In addition, those skilled in the art may add one or more other operations to the flowcharts or remove one or more operations from the flowcharts under the guidance of the contents of the embodiments of the present disclosure.

In addition, the described embodiments are only some but not all of the embodiments of the present disclosure. The components, generally described and illustrated in the drawings herein, of embodiments of the present disclosure may be arranged and designed in various configurations. Accordingly, the following detailed description of the embodiments of the present disclosure provided in the drawings is not intended to limit the scope of the claimed embodiments of the present disclosure, but merely represents selected embodiments of the embodiments of the present disclosure. Based on the embodiments of the present disclosure, all other embodiments obtained by a person skilled in the art without creative efforts fall within the protection scope of the embodiments of the present disclosure.

It should be noted that the term “including/include(s)/comprising/comprise(s)” will be used in embodiments of the present disclosure to indicate the presence of features claimed after this term, but does not exclude the addition of other features.

For visual target tracking, the embodiments of the present disclosure provide solutions that effectively reduce the complexity of prediction calculation during a tracking process. In the solutions, location information of an object to be tracked in an image to be tracked is predicted (in actual implementation, location information of a region to be positioned where the object to be tracked is located is predicted) based on an image similarity feature map between a search region in the image to be tracked and a target image region (including the object to be tracked) in a reference frame image, that is, a detection box of the object to be tracked in the image to be tracked is predicted. The detailed implementation process will be detailed in the following embodiments.

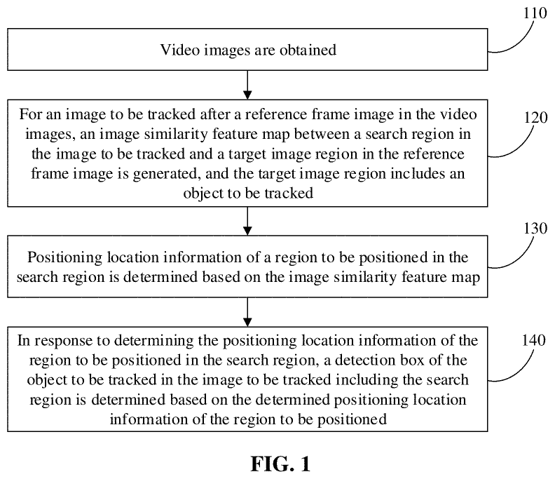

As illustrated in FIG. 1, an embodiment of the present disclosure provides a method for target tracking, which is performed by a terminal device for tracking and positioning an object to be tracked. The terminal device includes user equipment (UE), a mobile device, a user terminal, a terminal, a cellular phone, a cordless phone, a personal digital assistant (PDA), a handheld device, a computing device, an in-vehicle device, a wearable device, or the like. In some possible implementations, the method for target tracking is implemented by a processor through invoking computer-readable instructions stored in a memory. The method includes the following operations S110 to S140.

In operation S110, video images are obtained.

The video images are a sequence of images in which an object to be tracked needs to be positioned and tracked.

The video images include a reference frame image and at least one frame of image to be tracked. The reference frame image is an image including the object to be tracked. The reference frame image is a first frame image in the video images, or is another frame image in the video images. The image to be tracked is an image in which the object to be tracked needs to be searched and positioned. A location and a size (i.e., a detection box) of the object to be tracked in the reference frame image are already determined. A positioning region or a detection box in the image to be tracked, which is not determined, is a region that needs to be calculated and predicted (also referred to as a region to be positioned or the detection box in the image to be tracked).

In operation S120, for an image to be tracked after the reference frame image in the video images, an image similarity feature map between a search region in the image to be tracked and a target image region in the reference frame image is generated, here, the target image region includes the object to be tracked.

Before performing the operation S120, the search region is extracted from the image to be tracked, and the target image region is extracted from the reference frame image. The target image region includes the detection box of the object to be tracked. The search region includes a region to be positioned that has not been positioned. A location of the positioning region is a location of the object to be tracked.

After the search region and the target image region are extracted, image features are extracted from the search region and the target image region respectively, and image similarity features between the search region and the target image region are determined based on the image features corresponding to the search region and the image features corresponding to the target image region, that is, an image similarity feature map between the search region and the target image region is determined.

In operation S130, positioning location information of the region to be positioned in the search region is determined based on the image similarity feature map.

Here, based on the image similarity feature map generated in the operation S120, probability values of respective feature pixel points in a feature map of the search region are predicted and location relationship information between a respective pixel point, corresponding to each feature pixel point, in the search region and the region to be positioned is predicted.

A probability value of each feature pixel point represents a probability that a pixel point, corresponding to the feature pixel point, in the search region is located within the region to be positioned.

The location relationship information is deviation information between the pixel point in the search region in the image to be tracked and the center point of the region to be positioned in the image to be tracked. For example, if a coordinate system is established with the center point of the region to be positioned as a coordinate center, the location relationship information includes coordinate information of the corresponding pixel point in the established coordinate system.

Here, based on the probability values, a pixel point, with the largest probability of being located within the region to be positioned, in the search region is determined. Then, based on the location relationship information of the pixel point, the positioning location information of the region to be positioned in the search region is determined more accurately.

The positioning location information includes information such as coordinates of the center point of the region to be positioned. In actual implementation, the coordinate information of the center point of the region to be positioned is determined based on the coordinate information of the pixel point, with the largest probability of being located within the region to be positioned, in the search region and the deviation information between the pixel point (with the largest probability of being located within the region to be positioned) and the center point of the region to be positioned.

It should be noted that in the operation S130, the positioning location information of the region to be positioned in the search region is determined. However, in actual application, the region to be positioned may exist or may not exist in the search region. If no region to be positioned exists in the search region, the positioning location information of the region to be positioned is unable to be determined, that is, information such as the coordinates of the center point of the region to be positioned is unable to be determined.

In operation S140, in response to determining the positioning location information of the region to be positioned in the search region, a detection box of the object to be tracked in the image to be tracked including the search region is determined based on the determined positioning location information of the region to be positioned.

If the region to be positioned exists in the search region, in the operation S140, the detection box of the object to be tracked in the image to be tracked including the search region is determined based on the determined positioning location information of the region to be positioned. Here, the positioning location information of the region to be positioned in the image to be tracked is taken as the location information of the predicted detection box in the image to be tracked.

According to the above-described embodiment, the search region is extracted from the image to be tracked, the target image region is extracted from the reference frame image, and the positioning location information of the region to be positioned in the image to be tracked is predicted or determined based on the image similarity feature map between the extracted search region and the extracted target image region, that is, the detection box of the object to be tracked in the image to be tracked including the search region is determined, so that the number of pixel points for the prediction of the detection box is effectively reduced. According to the embodiments of the present disclosure, not only the efficiency and real-time performance of prediction are improved, but also the complexity of prediction calculation is reduced, so that a network architecture of the neural network used for predicting the detection box of the object to be tracked is simplified and more applicable to the mobile terminals with high requirements for real-time performance and network structure simplicity.

In some embodiments, the method for target tracking further includes predicting size information of the region to be positioned before determining the positioning location information of the region to be positioned in the search region. Here, respective size information of the region to be positioned corresponding to each pixel point in the search region is predicted based on the image similarity feature map generated in the operation S120. In the actual implementation, the size information includes a height value and a width value of the region to be positioned.

After the respective size information of the region to be positioned corresponding to each pixel point in the search region is determined, that operation that the positioning location information of the region to be positioned in the search region is determined based on the image similarity feature map includes the following operations 1 to 4.

At an operation 1, probability values of respective feature pixel points in a feature map of the search region are predicted based on the image similarity feature map. Here, a probability value of each feature pixel point represents a probability that a pixel point, corresponding to the feature pixel point, in the search region is located within the region to be positioned.

At an operation 2, location relationship information between a respective pixel point, corresponding to each feature pixel point, in the search region and the region to be positioned is predicted based on the image similarity feature map.

At an operation 3, a pixel point in the search region corresponding to a feature pixel point with a largest probability value among the predicted probability values is selected as a target pixel point.

At an operation 4, the positioning location information of the region to be positioned is determined based on the target pixel point, the location relationship information between the target pixel point and the region to be positioned, and the size information of the region to be positioned.

According to the operations 1 to 4, the coordinates of the center point of the region to be positioned are determined based on the location relationship information between the target pixel point (i.e., a pixel point, that is most likely to be located within the region to be positioned, in the search region) and the region to be positioned, and the coordinate information of the target pixel point in the region to be positioned. Further, by considering the size information of the region to be positioned corresponding to the target pixel point, the accuracy of determining the region to be positioned in the search region is improved, that is, the accuracy of tracking and positioning the object to be tracked is improved.

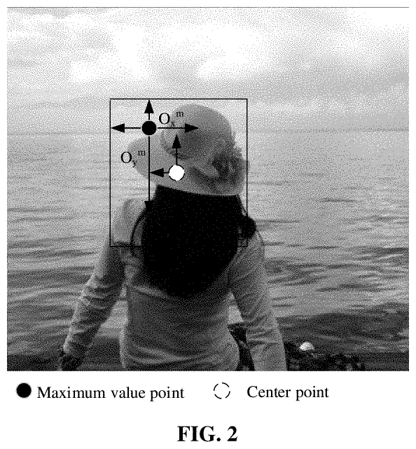

As illustrated in FIG. 2, a maximum value point in FIG. 2 is the pixel point most likely to be located within the region to be positioned, that is, the target pixel point with the largest probability. The coordinates of the center point x_{c}^{t}, y_{c}^{t}) of the region to be positioned are determined based on the coordinates (x^{m}, y^{m}) of the maximum value point and the location relationship information, (i.e., the deviation information O^{m}=(Oₓ^{m}, O_{y}^{m})) between the maximum value point and the region to be positioned. Here, Oₓ^{m} is a distance between the maximum value point and the center point of the region to be positioned in the direction of the horizontal axis and O_{y}^{m} is a distance between the maximum value point and the center point of the region to be positioned in the direction of the vertical axis. During the process of positioning the region to be positioned, the following formulas (1) to (5) are used for performing the positioning.

x_{c}^{t}=x^{m}+Oₓ^{m} (1)

y_{c}^{t}=y^{m}+O_{y}^{m} (2)

wₜ=w^{m} (3)

hₜ=h^{m} (4)

Rₜ=(x_{c}^{t},y_{c}^{t},wₜ,hₜ) (5)

Here, x_{c}^{t} represents an abscissa of the center point of the region to be positioned, y_{c}^{t} represents an ordinate of the center point of the region to be positioned, x^{m} represents an abscissa of the maximum value point, y^{m} represents an ordinate of the maximum value point, Oₓ^{m} represents the distance between the maximum value point and the center point of the region to be positioned in the direction of the horizontal axis, O_{y}^{m} represents a distance between the maximum value point and the center point of the region to be positioned in the direction of the vertical axis, wₜ represents a width value of the region to be positioned that has been positioned, hₜ represents a height value of the region to be positioned that has been positioned, w^{m} represents a width value of the region to be positioned obtained through prediction, h^{m} represents a height value of the region to be positioned obtained through prediction, and Rₜ represents location information of the region to be positioned that has been positioned.

In the above embodiment, after the image similarity feature map between the search region and the target image region is obtained, the target pixel point with the largest probability of being located within the region to be positioned is selected from the search region based on the image similarity feature map, and the positioning location information of the region to be positioned is determined based on coordinate information of the target pixel point with the largest probability in the search region, the location relationship information between the target pixel point and the region to be positioned, and the size information of the region to be positioned corresponding the target pixel point, so that the accuracy of the determined positioning location information is improved.

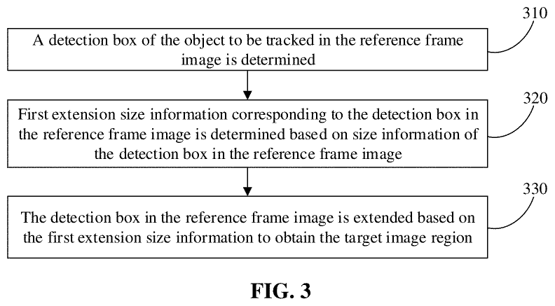

In some embodiments, as illustrated in FIG. 3, the target image region is extracted from the reference frame image based on the following operations S310 to S330.

In operation S310, the detection box of the object to be tracked in the reference frame image is determined.

The detection box is an image region that has been positioned and includes the object to be tracked. In the implementation, the detection box is a rectangular image box Rₜ_{₀}=(x_{c}^{t}^{₀}, t_{c}^{t}^{₀}, wₜ_{₀}, hₜ_{₀}), here, Rₜ_{₀} represents location information of the detection box, x_{c}^{t}^{₀} represents an abscissa of the center point of the detection box, y^{c}_{c}^{t}^{₀} represents an ordinate of the center point of the detection box, wₜ_{₀} represents a width value of the detection box, and hₜ_{₀} represents a height value of the detection box.

In operation S320, first extension size information corresponding to the detection box in the reference frame image is determined based on size information of the detection box in the reference frame image.

Here, the detection box is extended based on the first extension size information, and the average value of the height value of the detection box and the width value of the detection box is calculated as the first extension size information by using the following formula.

padₕ=pad_{w}=(wₜ_{₀}+hₜ_{₀})/2 (6)

Here, padₕ represents a length by which the detection box needs to be extended in the height of the detection box, pad_{w} represents a length by which the detection box needs to be extended in the width of the detection box, wₜ_{₀} represents the width value of the detection box, and hₜ_{₀} represents the height value of the detection box.

When performing the extension of the detection box, the detection box is extended by half of the value calculated above on both sides in the height direction of the detection box, respectively; and is extended by half of the value calculated above on both sides in the width direction the detection box, respectively.

In operation S330, the detection box in the reference frame image is extended based on the first extension size information to obtain the target image region.

Here, the detection box is extended based on the first extension size information to directly obtain the target image region. Alternatively, after the detection box is extended, the extended image is further processed to obtain the target image region. Alternatively, the detection box is not extended based on the first extension size information, but size information of the target image region is determined based on the first extension size information, and the detection box is extended based on the determined size information of the target image region to directly obtain the target image region.

The detection box is extended based on the size and location of the object to be tracked in the reference frame image (i.e., the size information of the detection box of the object to be tracked in the reference frame image), and the obtained target image region includes not only the object to be tracked but also the region around the object to be tracked, so that the target image region including more image contents is determined.

In some embodiments, the operation that the detection box in the reference frame image is extended based on the first extension size information to obtain the target image region includes following operations.

Size information of the target image region is determined based on the size information of the detection box and the first extension size information; and the target image region obtained by extending the detection box is determined based on the center point of the detection box and the size information of the target image region.

In the implementation, the size information of the target image region is determined by using the following formula (7). That is, the width wₜ_{₀} of the detection box is extended by a fixed size pad_{w}, the height hₜ_{₀} of the detection box is extended by a fixed size padₕ, and an arithmetic square root of values of the extended width and the extended height is calculated as a width (or a height) value of the target image region. That is, the target image region is a square region with the same height and width.

Rectₜ_{₀}^{w}=Rectₜ_{₀}^{h}=\sqrt{(wₜ_{_{0+pad}}_{w})*(hₜ_{_{0+pad}}ₕ)} (7)

Here, Rectₜ_{₀}^{w} represents the width value of the target image region and Rectₜ_{₀}^{h} represents the height value of the target image region; padₕ represents the length by which the detection box needs to be extended in the height of the detection box, and padₕ represents the length by which the detection box needs to be extended in the width of the detection box; and wₜ_{₀} represents the width value of the detection box, and hₜ_{₀} represents the height value of the detection box.

After the size information of the target image region is determined, the detection box is directly extended by taking the center point of the detection box as the center point and based on the determined size information, to obtain the target image region. Alternatively, the target image region is clipped, by taking the center point of the detection box as the center point and based on the determined size information, from the image obtained by extending the detection box based on the first extension size information.

According to the above-described embodiment, the detection box is extended based on the size information of the detection box and the first extension size information to obtain, the square target image region is clipped from the extended image obtained by extending the detection box, so that the obtained target image region does not include too many image regions other than the object to be tracked.

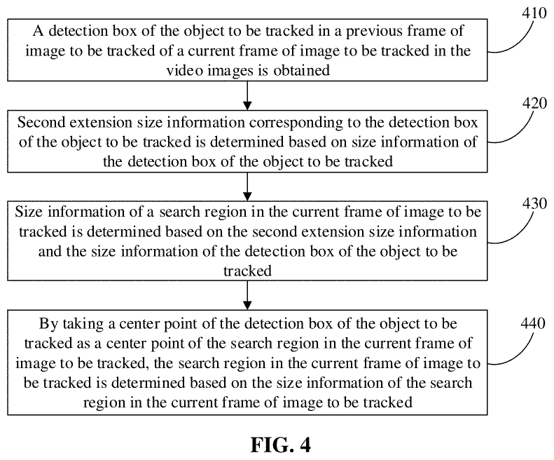

In some embodiments, as illustrated in FIG. 4, the search region is extracted from the image to be tracked based on the following operations S410 to S440.

In operation S410, a detection box of the object to be tracked in a previous frame of image to be tracked of a current frame of image to be tracked in the video images is obtained.

Here, the detection box in the previous frame of image to be tracked of the current frame of image to be tracked is an image region which has been positioned and the object to be tracked is located in.

In operation S420, second extension size information corresponding to the detection box of the object to be tracked is determined based on size information of the detection box of the object to be tracked.

Here, the calculation method for determining the second extension size information based on the size information of the detection box is the same as the calculation method for determining the first extension size information in the above-described embodiment, and details are not described herein again.

In operation S430, size information of a search region in the current frame of image to be tracked is determined based on the second extension size information and the size information of the detection box of the object to be tracked.

Here, the size information of the search region is determined based on the following operations.

Size information of a search region to be extended is determined based on the second extension size information and the size information of the detection box in the previous frame of image to be tracked; and the size information of the search region is determined based on the size information of the search region to be extended, a first preset size corresponding to the search region, and a second preset size corresponding to the target image region. The search region is obtained by extending the search region to be extended.

The calculation method for determining the size information of the search region to be extended is the same as the calculation method for determining the size information of the target image region based on the size information of the detection box and the first extension size information in the above-described embodiment, and details are not described herein again.

The determination of the size information of the search region (which is obtained by extending the search region to be extended) based on the size information of the search region to be extended, the first preset size corresponding to the search region, and the second preset size corresponding to the target image region is performed by using the following formulas (8) and (9).

$${SeachRect}_{{t}_{i}} = {Rect}_{{t}_{i}} + 2 * {Pad}_{margin} \qquad ( 8 )$$

$${Pad}_{margin} = ( {Size}_{s} - {Size}_{t} ) / ( 2 * \frac{{Size}_{t}}{{Rect}_{{t}_{i}}} ) \qquad ( 9 )$$

Here, SeachRectₜ_{ᵢ} represents the size information of the search region, Rectₜ_{ᵢ} represents the size information of the search region to be extended, Pad_{margin} represents a size by which the search region to be extended needs to be extended, Sizeₛ represents the first preset size corresponding to the search region, and Sizeₜ represents the second preset size corresponding to the target image region. Here, it is known based on the formula (7) that both the search region and the target image region are square regions with the same height and width, so the size here is the number of pixels corresponding to the height and width of the corresponding image region.

In the operation S430, the search region is further extended based on the size information of the search region to be extended, the first preset size corresponding to the search region, and the second preset size corresponding to the target image region, so that the search region is further enlarged. A larger search region will improve the success rate of tracking and positioning the object to be tracked.

In operation S440, by taking a center point of the detection box of the object to be tracked as a center point of the search region in the current frame of image to be tracked, the search region is determined based on the size information of the search region in the current frame of image to be tracked.

In the implementation, an initial positioning region in the current frame of image to be tracked is determined by taking the coordinates of the center point of the detection box in the previous frame of image to be tracked as a center point of the initial positioning region in the current frame of image to be tracked and by taking the size information of the detection box in the previous frame of image to be tracked as size information of the initial positioning region in the current frame of image to be tracked. The initial positioning region is extended based on the second extension size information, and the search region to be extended is clipped from the extended image based on the size information of the search region to be extended. Then, the search region is obtained by extending the search region to be extended based on the size information of the search region.

Alternatively, by taking the center point of the detection box in the previous frame of image to be tracked as the center point of the search region in the current frame of image to be tracked and based on the size information of the search region obtained by calculation, the search region is clipped directly from the current frame of image to be tracked.

The second extension size information is determined based on the size information of the detection box determined in the previous frame of image to be tracked. Based on the second extension size information, a larger search region is determined for the current frame of image to be tracked. The larger search region will improve the accuracy of the positioning location information of the determined region to be positioned, that is, the success rate of tracking and positioning the object to be tracked is improved.

In some embodiments, before the image similarity feature map is generated, the method for target tracking further includes following operations.

The search region is scaled to the first preset size, and the target image region is scaled to the second preset size.

Here, by setting the search region and the target image region to the corresponding preset sizes, the number of pixel points in the generated image similarity feature map is controlled, so that the complexity of the calculation is controlled.

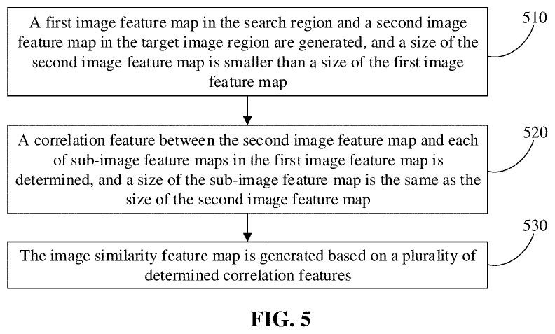

In some embodiments, as illustrated in FIG. 5, the image similarity feature map between the search region in the image to be tracked and the target image region in the reference frame image is generated, which includes the following operations S510 to S530.

In operation S510, a first image feature map in the search region and a second image feature map in the target image region are generated. A size of the second image feature map is smaller than a size of the first image feature map.

Here, the first image feature map and the second image feature map are obtained respectively by extracting the image features in the search region and the image features in the target image region through a deep convolutional neural network.

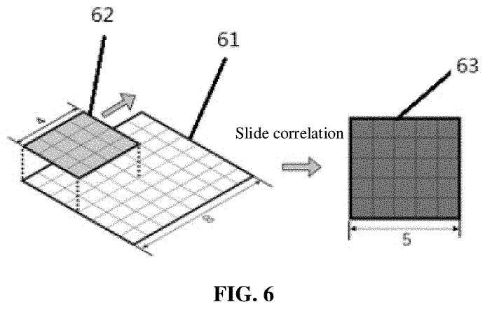

As illustrated in FIG. 6, both the width value and the height value of the first image feature map 61 are eight pixel points, and both the width value and the height value of the second image feature map 62 are four pixel points.

In operation S520, a correlation feature between the second image feature map and each of sub-image feature maps in the first image feature map is determined. A size of the sub-image feature map is the same as the size of the second image feature map.

As illustrated in FIG. 6, the second image feature map 62 is moved over the first image feature map 61 in an order of from left to right and from top to bottom, and respective orthographic projection regions of the second image feature map 62 on the first image feature map 61 are taken as respective sub-image feature maps.

In the implementation, the correlation feature between the second image feature map and the sub-image feature map is determined through the correlation calculation.

In operation S530, the image similarity feature map is generated based on a plurality of determined correlation features.

As illustrated in FIG. 6, based on the correlation feature between the second image feature map and each of the sub-image feature maps, both the width value and the height value of the generated image similarity feature map 63 are five pixel points.

A respective correlation feature corresponding to each pixel point in the image similarity feature map represents a degree of image similarity between a sub-region (i.e., sub-image feature map) in the first image feature map and the second image feature map. A pixel point, with the largest probability of being located in the region to be positioned, in the search region is selected accurately based on the degree of image similarity, and the accuracy of the positioning location information of the determined region to be positioned is effectively improved based on the information of the pixel point with the largest probability.

In the method for target tracking according to the above-described embodiment, the process of processing the obtained video images to obtain the positioning location information of the region to be tracked in each frame of image to be tracked and determining the detection box of the object to be tracked in the image to be tracked including the search region is performed through a tracking and positioning neural network, and the tracking and positioning neural network is obtained by training sample images labeled with a detection box of a target object.

In the method for target tracking, the tracking and positioning neural network is used to determine the positioning location information of the region to be positioned, that is, to determine the detection box of the object to be tracked in the image to be tracked including the search region. Since the calculation method is simplified, the structure of the tracking and positioning neural network is simplified, making it easier to be deployed on the mobile terminal.

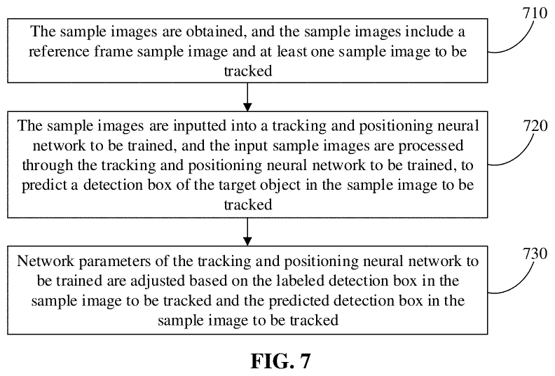

An embodiment of the present disclosure further provides a method for training the tracking and positioning neural network, as illustrated in FIG. 7, which includes following operations S710 to S730.

In operation S710, the sample images are obtained. The sample images include a reference frame sample image and at least one sample image to be tracked.

The sample image includes the reference frame sample image and the at least one frame of sample image to be tracked. The reference frame sample image includes a detection box of the object to be tracked, and positioning location information of the detection box has been determined. Positioning location information of a region to be positioned in the sample image to be tracked, which is not determined, is required to be predicted or determined through the tracking and positioning neural network.

In operation S720, the sample images are inputted into a tracking and positioning neural network to be trained, and the input sample images are processed through the tracking and positioning neural network to be trained, to predict a detection box of the target object in the sample image to be tracked.

In operation S730, network parameters of the tracking and positioning neural network to be trained are adjusted based on the labeled detection box in the sample image to be tracked and the predicted detection box in the sample image to be tracked.

In the implementation, the positioning location information of the region to be positioned in the sample image to be tracked is taken as location information of the predicted detection box in the sample image to be tracked.

The network parameters of the tracking and positioning neural network to be trained are adjusted based on the labeled detection box in the sample image to be tracked and the predicted detection box in the sample image to be tracked, which includes the following operations.

The network parameters of the tracking and positioning neural network to be trained are adjusted based on: size information of the predicted detection box, a predicted probability value that each pixel point in a search region in the sample image to be tracked is located within the predicted detection box, predicted location relationship information between each pixel point in the search region in the sample image to be tracked and the predicted detection box, standard size information of the labeled detection box, information about whether each pixel point in a standard search region in the sample image to be tracked is located within the labeled detection box, and standard location relationship information between each pixel point in the standard search region and the labeled detection box.

The standard size information, the information about whether each pixel point in the standard search region is located within the labeled detection box, and the standard location relationship information between each pixel point in the standard search region and the labeled detection box are all determined based on the labeled detection box.

The predicted location relationship information is deviation information between the corresponding pixel point and a center point of the predicted detection box, and includes a component of a distance between the corresponding pixel point and the center point in the direction of the horizontal axis and a component of the distance between the corresponding pixel point and the center point in the direction of the vertical axis.

The information about whether each pixel point is located within the labeled detection box is determined based on a standard value Lp indicating whether the pixel point is located within the labeled detection box, as shown in formula (10).

$${L}_{p} = \{ \begin{matrix}1 , {L}_{p}^{i} ∈ {R}_{t} \\ 0 , {L}_{p}^{i} ∉ {R}_{t}\end{matrix} \qquad ( 10 )$$

Here, Rₜ represents the detection box in the sample image to be tracked, and Lₚⁱ represents the standard value indicating whether the pixel point at the i-th position from left to right and from top to bottom in the search region is located within the detection box Rₜ. If the standard value Lp is 0, it indicates that the pixel point is outside the detection box Rₜ; if the standard value Lp is 1, it indicates that the pixel point is within the detection box Rₜ.

In the implementation, a sub-loss function Loss_{cls} is constructed by using a cross-entropy loss function to constrain the Lₚ and predicted probability values, as shown in formula (11).

$$L o s {s}_{cls} = {\sum }_{i in {k}_{p}} {L}_{p}^{i} log {y}_{i}^{1} + {\sum }_{i in {k}_{n}} {L}_{p}^{i} log {y}_{i}^{0} \qquad ( 11 )$$

Here, kₚ represents a set of pixel points within the labeled detection box, kₙ represents a set of pixel points outside the labeled detection box, yᵢ¹ represents a predicted probability value that the pixel point i is within the predicted detection box, and yᵢ⁰ represents a predicted probability value that the pixel point i is outside the predicted detection box.

In the implementation, a smooth L1 norm loss function (smoothL1) is used to determine a sub-loss function Loss_{offset} between the standard location relationship information and the predicted location relationship information, as shown in formula (12).

Loss_{offset}=smoothL1(Lₒ−Yₒ) (12)

Here, Yₒ represents the predicted location relationship information, and Lₒ represents the standard location relationship information.

The standard location relationship information Lₒ is true deviation information between the pixel point and a center point of the labeled detection box, and includes a component Lₒₓ of a distance between the pixel point and the center point of the labeled detection box in the direction of the horizontal axis and a component L_{oy} of the distance between the pixel point and the center point of the labeled detection box in the direction of the vertical axis.

Based on the sub-loss function generated by the above formula (11) and the sub-loss function generated by the above formula (12), a comprehensive loss function is constructed as shown in the following formula (13).

Lossₐₗₗ=Loss_{cls}+λ₁*Loss_{offset} (13)

Here, λ₁ is a preset weight coefficient.

Further, the network parameters of the tracking and positioning neural network to be trained are adjusted in combination with the predicted size information of the detection box. The sub-loss function Loss_{cls} and the sub-loss function Loss_{offset} are constructed by using the above formulas (11) and (12).

A sub-loss function Loss_{w,h} about the predicted size information of the detection box is constructed by using the following formula (14).

Loss_{w,h}=smoothL1(L_{w}−Y_{w})+smoothL1(Lₕ−Yₕ) (14)

Here, L_{w} represents a width value in the standard size information, Lₕ represents a height value in the standard size information, Y_{w} represents a width value in the predicted size information of the detection box, and Yₕ represents a height value in the predicted size information of the detection box.

A comprehensive loss function Lossₐₗₗ is constructed based on the above three sub-loss functions Loss_{cls}, Loss_{offset} and Loss_{w,h}, as illustrated in the following equation (15).

Lossₐₗₗ=Loss_{cls}+λ₁*Loss_{offset}+λ₂*Loss_{w,h} (15)

Here, λ₁ is a preset weight coefficient and λ₂ is another preset weight coefficient.

According to the above embodiment, in the process of training the tracking and positioning neural network, the loss function is constructed by further combining the predicted size information of the detection box and the standard size information of the detection box in the sample image to be tracked, and the loss function is used to further improve the calculation accuracy of the tracking and positioning neural network obtained through the training. The tracking and positioning neural network is trained by constructing the loss function based on the predicted probability value, the location relationship information, the predicted size information of the detection box and the corresponding standard value of the sample image, and the objective of the training is to minimize the value of the constructed loss function, which is beneficial to improve the calculation accuracy of the tracking and positioning neural network obtained through the training.

The methods for target tracking are classified into the generative methods and the discriminative methods according to the categories of observation models. In recent years, discriminative tracking methods mainly based on deep learning and correlation filtering have occupied a mainstream position, and have made a breakthrough progress in the target tracking technologies. In particular, various discriminative methods based on the image features obtained by deep learning have reached a leading level in tracking performance. The deep learning method utilizes its efficient feature expression ability obtained by end-to-end learning and training on large-scale image data, to make the target tracking algorithm more accurate and fast.

A cross-domain tracking method (Multi-Domain Network, MDNet) based on deep learning method learns, through a large number of off-line learning and on-line updating strategies, to obtain high-precision classifiers for targets and non-targets, and performs classification-discrimination and box-adjustment for the objects in subsequent frames, and finally obtains tracking results. Such tracking method based entirely on deep learning has a huge improvement in tracking accuracy but has poor real-time performance, for example, the number of frames per second (FPS) is 1. According to a Generic Object Tracking Using Regression Network (GOTURN) method proposed in the same year, the deep convolution neural network is used to extract the features of the adjacent frames of images, and learn the location changes of the target features relative to the previous frame to complete the target positioning operation of the subsequent frames. The method achieves high real-time performance, such as 100FPS, while maintaining a certain accuracy. Although the tracking method based on deep learning has better performance in both speed and accuracy, the computation complexity brought by the deeper network structures (such as VGG (Visual Geometry Group), ResNet (Residual Network), and/or the like) makes it difficult to apply the tracking algorithm with higher accuracy to the actual production.

For the tracking of any specified target object, the existing methods mainly include frame-by-frame detection, correlation filtering, and real-time tracking algorithm based on deep learning, and/or the like. These methods have some shortcomings in real-time performance, accuracy and structural complexity, and are not well suitable for complex tracking scenarios and actual mobile applications. The tracking method (such as MDNet) based on the detection and classification method requires online learning and is difficult to meet the real-time requirements. The correlation filtering-based and detection-based tracking algorithm is used to fine-tune the shape of the target box in the previous frame after predicting the location, and the resulting box is not accurate enough. The method based on the region candidate box such as RPN (RegionProposal Network) generates more redundant boxes and is computationally complex

The embodiments of the present disclosure aim to provide a method for target tracking that is optimized in terms of real-time performance of the algorithm while having higher accuracy.

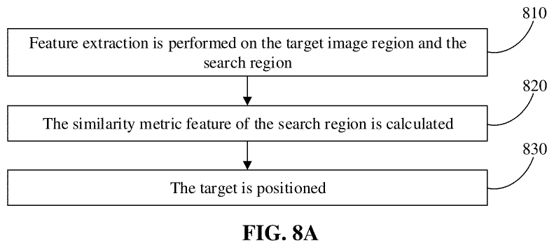

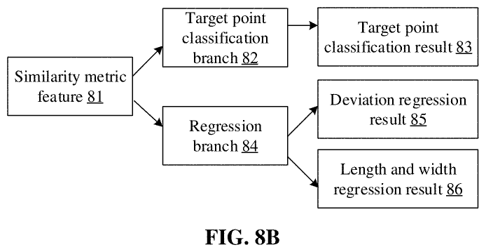

FIG. 8A is a schematic flowchart of a method for target tracking according to an embodiment of the disclosure. As illustrated in FIG. 8, the method includes following operations S810 to S830.

At an operation S810, feature extraction is performed on the target image region and the search region.

In the embodiment of the present disclosure, the target image region which is tracked is given in the form of a target box in an initial frame (i.e., the first frame). The search region is obtained by expanding a certain spatial region based on the tracking location and size of the target in the previous frame. The feature extraction is performed, through the same pre-trained deep convolution neural network, on the target region and search region which have been scaled to different fixed sizes, to obtain respective image features of the scaled target region and search region. That is, the image in which the target is located and the image to be tracked are taken as the input to the convolution neural network, and the features of the target image region and the features of the search region are output through the convolution neural network. These operations are described below.

Firstly, obtaining the target image region. In the embodiment of the present disclosure, the tracked object is video data. Generally, location information of a center of the target region is given in the form of a rectangular box in the first frame (the initial frame) that is tracked, such as Rₜ_{₀}=(x_{c}^{t}^{₀}, t_{c}^{t}^{₀}, wₜ_{₀}, hₜ_{₀}). By taking the location of the center of the target region as the center location, a square region Rectₜ_{₀} with the constant area is clipped according to the size information after padding (pad_{w}, padₕ) based on the target length and width.

Next, obtaining the search region. Based on the tracking result Rₜ_{ᵢ₋₁} of the previous frame (e.g., the given target box Rₜ_{₀} in the initial frame), a square region Rectₜ_{ᵢ} is obtained by taking the location of Rₜ_{ᵢ₋₁} as a center and performing the same processing as the target image region, in the current frame tᵢ. In order to include the target object as much as possible, a larger content information region is added on the basis of the square region to obtain the search region.

Then, obtaining the input images by scaling the obtained images. In the embodiment of the present disclosure, the image with the side length of Sizeₛ=255 pixels is taken as the input of the search region, and the image with the side length of Sizeₜ=127 pixels is taken as the input of the target image region. The search region SeachRect^{t}^{ᵢ} is scaled to a fixed size Sizeₛ and the target image region Rect^{t}^{₀} is scaled to a fixed size Sizeₜ.

Finally, feature extraction. The target feature Fₜ (i.e., the feature of the target image region) and the feature Fₛ of the search region are obtained by performing, through the deep convolution neural network, feature extraction respectively on the input images obtained by the scaling.

At an operation S820, the similarity metric feature of the search region is calculated.

The target feature Fₜ and the feature Fₛ of the search region are inputted. As illustrated in FIG. 6, the Fₜ is moved on the Fₛ in a manner of a sliding window, and the correlation calculation is performed on the search sub-region (sub-region with the same size as the target feature) and the target feature. Finally, the similarity metric feature F_{c} of the search region is obtained.

At an operation S830, the target is positioned.

In this operation, the similarity metric feature F_{c} is taken as the input, and finally a target point classification result Y, a deviation regression result Yₒ=(Yₒₓ, Y_{oy}), and a length and width result Y_{w}, Yₕ of the target box are output.

FIG. 8B illustrates a flowchart of positioning the target. A similarity metric feature 81 is fed into a target point classification branch 82 to obtain a target point classification result 83. The target point classification result 83 predicts whether a search region corresponding to each point is a target region to be searched. The similarity metric feature 81 is fed into a regression branch 84 to obtain a deviation regression result 85 of the target point and a length and width regression result 86 of the target box. The deviation regression result 85 predicts a deviation from the target point to a target center point. The length and width regression result 86 predicts the length and width of the target box. Finally, a location of the target center point is obtained based on location information of the target point with the highest similarity and the deviation information, and the final result about the target box at the location of the target center point is given based on the predicted result of the length and width of the target box. The two processes of algorithm training and positioning are described below.

The algorithm training process. The algorithm uses back propagation to perform an end-to end training on the feature extraction network and subsequent classification and regression branches. The class label Lₚ corresponding to the target point in the feature map is determined by the above formula (10). Each location on the target point classification result Y outputs a binary classification result to determine whether the location is located within the target box. The algorithm uses the cross-entropy loss function to constrain the Lₚ and Y, and adopts the smoothL1 calculation for a loss function about the deviation from the center point and the length and width regression output. Based on the loss functions defined above, the network parameters are trained by the calculation method of gradient backpropagation. After the model training is completed, the network parameters are fixed, and the preprocessed action region image is input into the network for feedforward to predict the target point classification result Y, the deviation regression result Yₒ, and the length and width result Y_{w}, Yₕ of the target box in the current frame.

The algorithm positioning process. Based on the location x^{m} and y^{m} of the maximum value point taken from the classification result Y, the deviation O^{m}=(Oₓ^{m}, O_{y}^{m}) obtained by prediction based on the maximum value point, and predicted length and width information w^{m}, h^{m}, the target region Rₜ in a new frame is calculated by using formulas (1) to (5).

According to the embodiments of the present disclosure, the image similarity feature map between the search region in the image to be tracked and the target image region in the reference frame is determined, and positioning location information of the region to be positioned in the image to be tracked is predicted or determined based on the image similarity feature map (i.e., a detection box of the object to be tracked in the image to be tracked including the search region is determined), so that the number of pixel points involved in predicting the detection box of the object to be tracked is effectively reduced, which not only improves the prediction efficiency and real-time performance, but also reduces the calculation complexity of prediction, thereby simplifying the network architecture of the neural network for predicting the detection box of the object to be tracked, and making it more applicable to the mobile terminals that have a high requirement for real-time performance and network structure simplicity.

According to the embodiment of the present disclosure, the predicted target is fully trained by the end-to-end training method, which does not require the online updating and has the high real-time performance. Moreover, the point location, deviation and length and width of the target box are predicted directly through the network, and the final target box information is obtained directly through calculation, so the network structure is simpler and more effective, and there is no prediction process of the candidate box, so that it is more suitable for the algorithm requirements of the mobile terminals, and the real-time performance of the tracking algorithms is maintained while improving the accuracy. The algorithms provided by the embodiments of the present disclosure are used for tracking algorithm applications on mobile terminals and embedded devices, such as face tracking in terminal devices, target tracking through drones, and other scenarios. The algorithms are used to cooperate with mobile or embedded devices to complete high-speed movements that are difficult to follow by humans, as well as real-time intelligent tracking and direction correction tracking tasks for the specified objects.

Corresponding to the above-described method for target tracking, the embodiments of the present disclosure further provide an apparatus for target tracking. The apparatus is for use in a terminal device that needs to perform the target tracking, and the apparatus and its respective modules perform the same operations as the above-described method for target tracking, and achieve the same or similar beneficial effects, and therefore repeated parts are not described here.

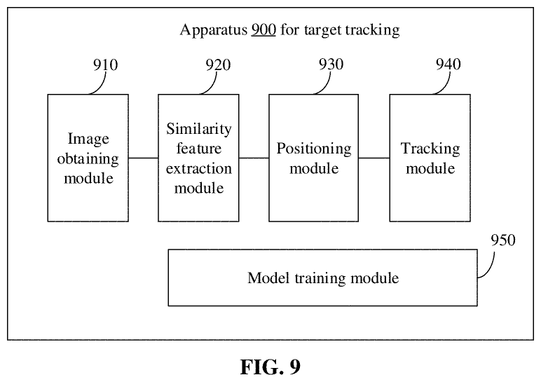

As illustrated in FIG. 9, the apparatus for target tracking provided by the embodiments of the present disclosure includes an image obtaining module 910, a similarity feature extraction module 920, a positioning module 930 and a tracking module 940.

The image obtaining module 910 is configured to obtain video images.

The similarity feature extraction module 920 is configured to: for an image to be tracked after a reference frame image in the video images, generate an image similarity feature map between a search region in the image to be tracked and a target image region in the reference frame image. The target image region includes an object to be tracked.

The positioning module 930 is configured to determine, based on the image similarity feature map, positioning location information of a region to be positioned in the search region.

The tracking module 940 is configured to: in response to determining the positioning location information of the region to be positioned in the search region, determine, based on the determined positioning location information of the region to be positioned, a detection box of the object to be tracked in the image to be tracked including the search region.

In some embodiments, the positioning module 930 is configured to: predict, based on the image similarity feature map, size information of the region to be positioned; predict, based on the image similarity feature map, probability values of respective feature pixel points in a feature map of the search region, a probability value of each feature pixel point represents a probability that a pixel point corresponding to the feature pixel point in the search region is located within the region to be positioned; predict, based on the image similarity feature map, location relationship information between a respective pixel point corresponding to each feature pixel point and the region to be positioned in the search region; select, as a target pixel point, a pixel point in the search region corresponding to a feature pixel point with a largest probability value among the predicted probability values; and determine the positioning location information of the region to be positioned based on the target pixel point, the location relationship information between the target pixel point and the region to be positioned, and the size information of the region to be positioned.

In some embodiments, the similarity feature extraction module 920 is configured to extract the target image region from the reference frame image by: determining a detection box of the object to be tracked in the reference frame image; determining, based on size information of the detection box in the reference frame image, first extension size information corresponding to the detection box in the reference frame image; and extending, based on the first extension size information, the detection box in the reference frame image, to obtain the target image region.

In some embodiments, the similarity feature extraction module 920 is configured to extract the search region from the image to be tracked by: obtaining a detection box of the object to be tracked in a previous frame of image to be tracked of a current frame of image to be tracked in the video images; determining, based on size information of the detection box of the object to be tracked, second extension size information corresponding to the detection box of the object to be tracked; determining size information of a search region in the current frame of image to be tracked based on the second extension size information and the size information of the detection box of the object to be tracked; and determining, based on the size information of the search region in the current frame of image to be tracked, the search region in the current frame of image to be tracked by taking a center point of the detection box of the object to be tracked as a center point of the search region in the current frame of image to be tracked.

In some embodiments, the similarity feature extraction module 920 is configured to scale the search region to a first preset size, and scale the target image region to a second preset size; generate a first image feature map in the search region and a second image feature map in the target image region, a size of the second image feature map is smaller than a size of the first image feature map; determine a correlation feature between the second image feature map and each of sub-image feature maps in the first image feature map, a size of the sub-image feature map is the same as the size of the second image feature map; and generate the image similarity feature map based on a plurality of determined correlation features.

In some embodiments, the apparatus for target tracking is configured to determine, through a tracking and positioning neural network, the detection box of the object to be tracked in the image to be tracked including the search region, and the tracking and positioning neural network is obtained by training sample images labeled with a detection box of a target object.

In some embodiments, the apparatus for target tracking further includes a model training module 950 configured to: obtain the sample images, the sample images include a reference frame sample image and at least one sample image to be tracked; input the sample images into a tracking and positioning neural network to be trained, process, through the tracking and positioning neural network to be trained, the input sample images to predict a detection box of the target object in the sample image to be tracked; and adjust network parameters of the tracking and positioning neural network to be trained based on the labeled detection box in the sample image to be tracked and the predicted detection box in the sample image to be tracked.

In some embodiments, positioning location information of a region to be positioned in the sample image to be tracked is taken as location information of the predicted detection box in the sample image to be tracked, and the model training module 950 is configured to, when adjusting the network parameters of the tracking and positioning neural network to be trained based on the labeled detection box in the sample image to be tracked and the predicted detection box in the sample image to be tracked, adjust the network parameters of the tracking and positioning neural network to be trained based on: size information of the predicted detection box, a predicted probability value that each pixel point in a search region in the sample image to be tracked is located within the predicted detection box, predicted location relationship information between each pixel point in the search region in the sample image to be tracked and the predicted detection box, standard size information of the labeled detection box, information about whether each pixel point in a standard search region in the sample image to be tracked is located within the labeled detection box; and standard location relationship information between each pixel point in the standard search region and the labeled detection box.

In the embodiments of the present disclosure, for the implementation of the apparatus for target tracking during predicting the detection box, the reference is made to the description of the method for target tracking. The implementation process is similar to the description of the method for target tracking, and details are not described herein again.

Embodiments of the present disclosure disclose an electronic device including a processor 1001, a memory 1002, and a bus 1003. The memory 1002 is configured to store machine-readable instructions executable by the processor 1001. The processor 1001 is configured to communicate with the memory 1002 via the bus 1003 when the electronic device operates.

The machine-readable instructions, when executed by the processor 1001, perform the following operations. Video images are obtained. For an image to be tracked after a reference frame image in the video images, an image similarity feature map between a search region in the image to be tracked and a target image region in the reference frame image is generated. The target image region includes an object to be tracked. Positioning location information of a region to be positioned in the search region is determined based on the image similarity feature map. In response to determining the positioning location information of the region to be positioned in the search region, a detection box of the object to be tracked in the image to be tracked including the search region is determined based on the determined positioning location information of the region to be positioned.

In addition, the machine-readable instructions, when executed by the processor 1001, cause the processor to perform the method contents in any implementation of the above method embodiments, and details are not described herein again.

Embodiments of the present disclosure further provide a computer program product corresponding to the above-described method and apparatus, including a computer-readable storage medium having stored thereon program code. The program code includes instructions that are used to perform the methods in the method embodiments. For an implementation process, the reference is made to the method embodiments, and details are not described herein again.

The above description of the various embodiments tends to emphasize the differences between the various embodiments, the same or similar contents of which may refer to each other, and for brevity, details are not described herein.

Those skilled in the art clearly understand that in order to the convenience and conciseness of the description, for the specific working processes of the above-described system and apparatus, the reference is made to the corresponding processes in the foregoing method embodiments, and thus details are not described herein. In the several embodiments provided by the disclosure, it should be understood that the disclosed system, apparatus and method may be implemented in other ways. For example, the apparatus embodiments described above are only illustrative. For example, the division of the units is only a logical function division, and there may be other divisions in actual implementation. For example, multiple modules or components may be combined or integrated into another system, or some features may be ignored or not implemented. In addition, the displayed or discussed mutual coupling or direct coupling or communication connection may be indirect coupling or communication connection through some interfaces, apparatuses or modules, and may be in electrical, mechanical or other forms.

The modules described as separate components may or may not be physically separated, and the components displayed as modules may or may not be physical units, that is, they may be located in one place, or they may be distributed on multiple network units. Some or all of the units may be selected according to actual needs to achieve the objectives of the solutions of the present embodiments.

In addition, the functional units in each embodiment of the disclosure may be integrated into one processing unit, or each unit may exist separately and physically, or two or more units may be integrated into one unit.

The function, if implemented in the form of a software functional unit and is sold or used as an independent product, can be stored in a computer readable storage medium. Based on such an understanding, the technical solution of the embodiments of the disclosure or the part that contributes to the related art or the part of the technical solution may be embodied in the form of a software product. The computer software product is stored in a storage medium, including several instructions to make a computer device (which may be a personal computer, a server or a network device, or the like) execute all or part of the operations of the methods described in the each embodiment of the disclosure. The aforementioned storage medium includes: U disks, mobile hard disks, read-only memories (ROM), random access memories (RAM), magnetic disks or optical disks and other media that store program codes.

The foregoing is only the specific implementation of the embodiments of the disclosure. However, the protection scope of the disclosure is not limited thereto. Any variations or replacements apparent to those skilled in the art within the technical scope disclosed by the present disclosure shall fall within the protection scope of the present disclosure. Therefore, the protection scope of the disclosure shall be subject to the protection scope of the claims.

### INDUSTRIAL PRACTICABILITY

In the embodiments of the present disclosure, the predicted target box is fully trained through the end-to-end training method, which does not require the online updating, and has high the real-time performance. Moreover, the final target box information is directly obtained by directly predicting the point location, deviation, and the length and width result of the target box through the tracking network. The network structure is simpler and more efficient, and there is no prediction process of candidate boxes, which is more suitable for the algorithm requirements of the mobile terminal, and maintains the real-time performance of the tracking algorithm while improving the accuracy.

1. A method for target tracking, comprising:
obtaining video images;
for an image to be tracked after a reference frame image in the video images, generating an image similarity feature map between a search region in the image to be tracked and a target image region in the reference frame image, wherein the target image region comprises an object to be tracked;
determining, based on the image similarity feature map, positioning location information of a region to be positioned in the search region; and
in response to determining the positioning location information of the region to be positioned in the search region, determining, based on the determined positioning location information of the region to be positioned, a detection box of the object to be tracked in the image to be tracked comprising the search region.

2. The method for target tracking of claim 1, wherein determining, based on the image similarity feature map, the positioning location information of the region to be positioned in the search region comprises:
predicting, based on the image similarity feature map, size information of the region to be positioned;
predicting, based on the image similarity feature map, probability values of respective feature pixel points in a feature map of the search region, wherein a probability value of each feature pixel point represents a probability that a pixel point corresponding to the feature pixel point in the search region is located within the region to be positioned;
predicting, based on the image similarity feature map, location relationship information between a respective pixel point corresponding to each feature pixel point in the search region and the region to be positioned;
selecting, as a target pixel point, a pixel point in the search region corresponding to a feature pixel point with a largest probability value among the predicted probability values; and
determining the positioning location information of the region to be positioned based on the target pixel point, the location relationship information between the target pixel point and the region to be positioned, and the size information of the region to be positioned.

3. The method for target tracking of claim 1, further comprising: extracting the target image region from the reference frame image by:
determining a detection box of the object to be tracked in the reference frame image;
determining, based on size information of the detection box in the reference frame image, first extension size information corresponding to the detection box in the reference frame image; and
extending, based on the first extension size information, the detection box in the reference frame image, to obtain the target image region.

4. The method for target tracking of claim 1, further comprising: extracting the search region from the image to be tracked by:
obtaining a detection box of the object to be tracked in a previous frame of image to be tracked of a current frame of image to be tracked in the video images;
determining, based on size information of the detection box of the object to be tracked, second extension size information corresponding to the detection box of the object to be tracked;
determining size information of a search region in the current frame of image to be tracked based on the second extension size information and the size information of the detection box of the object to be tracked; and
determining, based on the size information of the search region in the current frame of image to be tracked, the search region by taking a center point of the detection box of the object to be tracked as a center point of the search region in the current frame of image to be tracked.

5. The method for target tracking of claim 1, wherein generating the image similarity feature map between the search region in the image to be tracked and the target image region in the reference frame image comprises:
scaling the search region to a first preset size, and scaling the target image region to a second preset size;
generating a first image feature map in the search region and a second image feature map in the target image region, wherein a size of the second image feature map is smaller than a size of the first image feature map;
determining a correlation feature between the second image feature map and each of sub-image feature maps in the first image feature map, wherein a size of the sub-image feature map is the same as the size of the second image feature map; and
generating the image similarity feature map based on a plurality of determined correlation features.

6. The method for target tracking of claim 1, wherein the method for target tracking is performed by a tracking and positioning neural network, and wherein the tracking and positioning neural network is obtained by training sample images labeled with a detection box of a target object.

7. The method for target tracking of claim 6, further comprising: training the tracking and positioning neural network comprising:
obtaining the sample images, wherein the sample images comprise a reference frame sample image and at least one sample image to be tracked;
inputting the sample images into a tracking and positioning neural network to be trained, and processing, through the tracking and positioning neural network to be trained, the input sample images to predict a detection box of the target object in the sample image to be tracked; and
adjusting network parameters of the tracking and positioning neural network to be trained based on the labeled detection box in the sample image to be tracked and the predicted detection box in the sample image to be tracked.

8. The method for target tracking of claim 7, wherein positioning location information of a region to be positioned in the sample image to be tracked is taken as location information of the predicted detection box in the sample image to be tracked, and
wherein adjusting the network parameters of the tracking and positioning neural network to be trained based on the labeled detection box in the sample image to be tracked and the predicted detection box in the sample image to be tracked comprises:
adjusting the network parameters of the tracking and positioning neural network to be trained based on:
size information of the predicted detection box,
a predicted probability value that each pixel point in a search region in the sample image to be tracked is located within the predicted detection box,
predicted location relationship information between each pixel point in the search region in the sample image to be tracked and the predicted detection box,
standard size information of the labeled detection box,
information about whether each pixel point in a standard search region in the sample image to be tracked is located within the labeled detection box, and
standard location relationship information between each pixel point in the standard search region and the labeled detection box.

9. An electronic device, comprising:
a processor; and
a memory, coupled with the processor through a bus and configured to store computer instructions that, when executed by the processor, cause the processor to:
obtain video images;
for an image to be tracked after a reference frame image in the video images, generate an image similarity feature map between a search region in the image to be tracked and a target image region in the reference frame image, wherein the target image region comprises an object to be tracked;
determine, based on the image similarity feature map, positioning location information of a region to be positioned in the search region; and
in response to determining the positioning location information of the region to be positioned in the search region, determine, based on the determined positioning location information of the region to be positioned, a detection box of the object to be tracked in the image to be tracked comprising the search region.

10. The electronic device of claim 9, wherein the processor is configured to:
predict, based on the image similarity feature map, size information of the region to be positioned;
predict, based on the image similarity feature map, probability values of respective feature pixel points in a feature map of the search region, wherein a probability value of each feature pixel point represents a probability that a pixel point corresponding to the feature pixel point in the search region is located within the region to be positioned;
predict, based on the image similarity feature map, location relationship information between a respective pixel point corresponding to each feature pixel point in the search region and the region to be positioned;
select, as a target pixel point, a pixel point in the search region corresponding to a feature pixel point with a largest probability value among the predicted probability values; and
determine the positioning location information of the region to be positioned based on the target pixel point, the location relationship information between the target pixel point and the region to be positioned, and the size information of the region to be positioned.

11. The electronic device of claim 9, wherein the processor is configured to extract the target image region from the reference frame image by:
determining a detection box of the object to be tracked in the reference frame image;
determining, based on size information of the detection box in the reference frame image, first extension size information corresponding to the detection box in the reference frame image; and
extending, based on the first extension size information, the detection box in the reference frame image, to obtain the target image region.

12. The electronic device of claim 9, wherein the processor is configured to extract the search region from the image to be tracked by:
obtaining a detection box of the object to be tracked in a previous frame of image to be tracked of a current frame of image to be tracked in the video images;
determining, based on size information of the detection box of the object to be tracked, second extension size information corresponding to the detection box of the object to be tracked;
determining size information of a search region in the current frame of image to be tracked based on the second extension size information and the size information of the detection box of the object to be tracked; and
determining, based on the size information of the search region in the current frame of image to be tracked, the search region by taking a center point of the detection box of the object to be tracked as a center point of the search region in the current frame of image to be tracked.

13. The electronic device of claim 9, wherein the processor is configured to:
scale the search region to a first preset size, and scale the target image region to a second preset size;
generate a first image feature map in the search region and a second image feature map in the target image region, wherein a size of the second image feature map is smaller than a size of the first image feature map;
determine a correlation feature between the second image feature map and each of sub-image feature maps in the first image feature map, wherein a size of the sub-image feature map is the same as the size of the second image feature map; and
generate the image similarity feature map based on a plurality of determined correlation features.

14. The electronic device of claim 9, wherein the electronic device is configured to determine, through a tracking and positioning neural network, the detection box of the object to be tracked in the image to be tracked comprising the search region, and wherein the tracking and positioning neural network is obtained by training sample images labeled with a detection box of a target object.

15. The electronic device of claim 14, wherein the processor is configured to:
obtain the sample images, wherein the sample images comprise a reference frame sample image and at least one sample image to be tracked;
input the sample images into a tracking and positioning neural network to be trained, process, through the tracking and positioning neural network to be trained, the input sample images to predict a detection box of the target object in the sample image to be tracked; and
adjust network parameters of the tracking and positioning neural network to be trained based on the labeled detection box in the sample image to be tracked and the predicted detection box in the sample image to be tracked.

16. The electronic device of claim 15, wherein positioning location information of a region to be positioned in the sample image to be tracked is taken as location information of the predicted detection box in the sample image to be tracked, and
wherein the processor is configured to, when adjusting the network parameters of the tracking and positioning neural network to be trained based on the labeled detection box in the sample image to be tracked and the predicted detection box in the sample image to be tracked, adjust the network parameters of the tracking and positioning neural network to be trained based on:
size information of the predicted detection box in the sample image to be tracked,
a predicted probability value that each pixel point in a search region in the sample image to be tracked is located within the predicted detection box in the sample image to be tracked,
predicted location relationship information between each pixel point in the search region in the sample image to be tracked and the predicted detection box in the sample image to be tracked,
standard size information of the labeled detection box in the sample image to be tracked,
information about whether each pixel point in a standard search region in the sample image to be tracked is located within the labeled detection box, and
standard location relationship information between each pixel point in the standard search region in the sample image to be tracked and the labeled detection box in the sample image to be tracked.

17. A non-transitory computer-readable storage medium having stored thereon a computer program that, when executed by a processor, causes the processor to perform a method for target tracking comprising:
obtaining video images;
for an image to be tracked after a reference frame image in the video images, generating an image similarity feature map between a search region in the image to be tracked and a target image region in the reference frame image, wherein the target image region comprises an object to be tracked;
determining, based on the image similarity feature map, positioning location information of a region to be positioned in the search region; and
in response to determining the positioning location information of the region to be positioned in the search region, determining, based on the determined positioning location information of the region to be positioned, a detection box of the object to be tracked in the image to be tracked comprising the search region.

18. The non-transitory computer-readable storage medium of claim 17, wherein determining, based on the image similarity feature map, the positioning location information of the region to be positioned in the search region comprises:
predicting, based on the image similarity feature map, size information of the region to be positioned;
predicting, based on the image similarity feature map, probability values of respective feature pixel points in a feature map of the search region, wherein a probability value of each feature pixel point represents a probability that a pixel point corresponding to the feature pixel point in the search region is located within the region to be positioned;
predicting, based on the image similarity feature map, location relationship information between a respective pixel point corresponding to each feature pixel point in the search region and the region to be positioned;
selecting, as a target pixel point, a pixel point in the search region corresponding to a feature pixel point with a largest probability value among the predicted probability values; and
determining the positioning location information of the region to be positioned based on the target pixel point, the location relationship information between the target pixel point and the region to be positioned, and the size information of the region to be positioned.

19. The non-transitory computer-readable storage medium of claim 17, wherein the method further comprising: extracting the target image region from the reference frame image by:
determining a detection box of the object to be tracked in the reference frame image;
determining, based on size information of the detection box in the reference frame image, first extension size information corresponding to the detection box in the reference frame image; and
extending, based on the first extension size information, the detection box in the reference frame image, to obtain the target image region.

20. The non-transitory computer-readable storage medium of claim 17, wherein the method further comprising: extracting the search region from the image to be tracked by:
obtaining a detection box of the object to be tracked in a previous frame of image to be tracked of a current frame of image to be tracked in the video images;
determining, based on size information of the detection box of the object to be tracked, second extension size information corresponding to the detection box of the object to be tracked;
determining size information of a search region in the current frame of image to be tracked based on the second extension size information and the size information of the detection box of the object to be tracked; and
determining, based on the size information of the search region in the current frame of image to be tracked, the search region by taking a center point of the detection box of the object to be tracked as a center point of the search region in the current frame of image to be tracked.
